(19) United States
(12) Patent Application Publication
(10) Pub. No.: US 2006/0219449 A1
(43) Pub. Date: Oct. 5, 2006

(54) Driving unit for driving vehicle by motor

(76) Inventors: Ryoji Mizutani, Nishikamo-gun (JP); Atsushi Torii, Nishio-shi (JP); Yuki Tojima, Chita-gun (JP)

Correspondence Address: KENYON & KENYON LLP, 1500 K STREET N.W., SUITE 700, WASHINGTON, DC, 20005, US

(21) Appl. No.: 11/362,845

(22) Filed: Feb. 28, 2006

(30) Foreign Application Priority Data
Mar. 2, 2005 (JP) 2005-057453 (P)

(51) Int. Cl. B60K 1/00

(52) U.S. Cl. 180/65.5

(57) ABSTRACT

A bearing for supporting rotation of either of a rotor and a planetary gear is supported by a wall disposed between a motor housing and a gear case room. The wall is provided with an opening allowing lubricating oil splashed by a gear to be splashed onto an upper portion of a stator. Some of the lubricating oil passes through an oil passage placed at a central portion of a shaft and through an oil passage provided at a planetary carrier, and is then splashed through the opening onto an outer periphery of a stator coil. Furthermore, the lubricating oil is also splashed by a pinion gear, and is similarly splashed through the opening onto the stator coil and an inner peripheral wall of the motor housing. Accordingly, the stator coil and the stator core are cooled.

This nonprovisional application is based on Japanese Patent Application No. 2005-057453 filed with the Japan Patent Office on Mar. 2, 2005, the entire contents of which are hereby incorporated by reference.

### BACKGROUND OF THE INVENTION

1. Field of the Invention

The present invention relates to a driving unit, and more particularly, to a driving unit for driving a vehicle by a motor.

2. Description of the Background Art

In recent years, from the viewpoints of environmental protection and fuel efficiency, attention has been focused on a vehicle whose wheels are driven by an electric motor. Examples of such a vehicle include an electric vehicle, a hybrid vehicle, and a fuel cell vehicle.

As one of driving units to be mounted on such a vehicle, an inwheel motor has been developed. The inwheel motor is a driving motor individually provided inside each of the wheels. The inwheel motor enables easy control of torque in each of the wheels, and is expected to exert effects over a bad road such as a low-friction, snowy road.

However, since the inwheel motor is placed at a position less likely to catch airflow generated by the vehicle's travel, it requires efficient heat radiation.

Since the space within the wheel is limited, it may be contemplated to circulate cooling water, cooling oil, or the like from a radiator placed at the vehicle body. However, it is necessary to connect a power cable and a sensor signal cable for the motor, and a hydraulic pressure transmitting hose for the brake, for example, to the inwheel motor from the vehicle body. Therefore, it is difficult to further connect any other hoses such as those for cooling water to the inwheel motor.

Japanese Patent Laying-Open No. 09-071139 discloses a technology pertinent to a hybrid-type vehicle that enables a coil in an inwheel motor to be cooled sufficiently, while the size of a driving unit is prevented from being enlarged.

This technology shows a driving unit having an internal combustion engine, a transmission shaft for transmitting rotation from the internal combustion engine, a generator equipped with a rotor fixed to the transmission shaft, a stator fixed to a case, and a coil, an electric motor driven by current being supplied, and a brake engageably and releasably provided and, when engaged, halting the rotation of the rotor in the generator.

The brake is provided at the end of and at the inner peripheral side of the coil in the generator, and a notch is formed at a cylindrical brake support portion supporting the brake. Through the notch, oil, which has already been used to cool the brake, is splashed onto the inner peripheral surface of the coil. Since such a structure allows the inside of the coil to be cooled, there is no need to provide another cooling apparatus inside the coil.

In the technology disclosed in Japanese Patent Laying-Open No. 09-071139, oil, which has already been used to cool the brake, is splashed onto the inner peripheral surface of the coil. Therefore, the outside of the coil is not sufficiently cooled. Furthermore, when the lubricating oil is splashed inside the coil, it can enter a gap portion between the rotor and the stator. If the lubricating oil enters the gap portion between the rotor and the stator, resistance occurs for shearing the lubricating oil, which can disadvantageously increase force loss in rotating the rotor.

### SUMMARY OF THE INVENTION

An object of the present invention is to provide a driving unit for a vehicle in which cooling performance is improved.

To be brief, the present invention is a driving unit, including: a motor room accommodating a stator and a rotor; a gear room arranged adjacently to the motor room along a direction of a rotation axis of the rotor and accommodating a gear, rotation of the rotor being transmitted to the gear; a bearing for supporting rotation of either of the rotor and the gear; and a wall disposed between the motor room and the gear room for supporting the bearing. The wall is provided with an opening for allowing lubricating oil splashed by the gear to be splashed onto an upper portion of the stator.

Preferably, the driving unit is placed in a wheel of a vehicle.

Preferably, the gear is a reduction gear decelerating the rotation of the rotor and transmitting the rotation to a shaft causing the wheel to rotate. The reduction gear includes a ring gear fixed to a wall of the gear room, a sun gear to which the rotation of the rotor is transmitted, a planetary carrier fitted into the shaft, and a pinion gear having a rotating shaft supported by the planetary carrier and engaging the sun gear and the ring gear.

Preferably, the driving unit further includes a cooling fin provided outside a wall portion of the motor room, the lubricating oil splashed from the gear through the opening adhering to the wall portion of the motor room.

According to the present invention, the lubricating oil, which has been splashed by the gear to which the rotation of the rotor is transmitted, is supplied to the upper portion of the stator by being splashed through the opening. Therefore, better heat radiation is achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a driving unit according to an embodiment of the present invention.

FIG. 2 is a schematic cross section of the driving unit according to the embodiment of the present invention.

FIG. 3 is a perspective view showing how a gear case 545 and a motor housing 544 in FIG. 2 are assembled.

FIG. 4 is a perspective view showing a state shown in FIG. 3 with gear case 545 removed.

FIG. 5 is a view for explaining a flow of lubricating oil splashed by a reduction gear.

### DESCRIPTION OF THE PREFERRED EMBODIMENT

An embodiment of the present invention will hereinafter be described in detail with reference to the drawings. The same or similar parts in the drawings are provided with the same reference characters, and the description thereof will not be repeated.

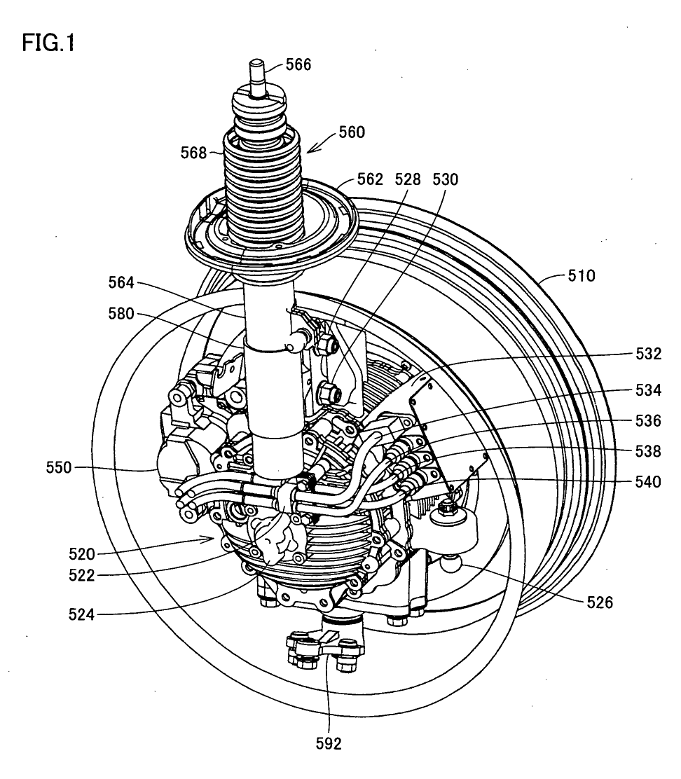

FIG. 1 is a perspective view of a driving unit according to an embodiment of the present invention.

Referring to FIG. 1, the driving unit includes a wheel 510, an inwheel motor 520 placed in the wheel, and a shock absorber 560 placed at the inwheel motor on the inner, vehicle body side and elongating and contracting in accordance with the vertical movement of wheel 510. Shock absorber 560 includes an outer cylinder 564 in which oil, nitrogen gas, or the like is enclosed, a piston rod 566 where a piston that slides in the outer cylinder is attached to its tip, an absorber cover 568 for covering the piston rod, and a spring sheet 562 on which a spring coil not shown is placed.

Inwheel motor 520 is provided with a terminal box 532 in which a connector for each of a sensor cable 534, and power cables 536, 538 and 540 of U phase, V phase and W phase, respectively, is placed, a wiring clamp 522 for fixing cables 534, 536, 538, and 540 to a case of inwheel motor 520, a brake caliper 550 accommodating brake pads for sandwiching and pressing a brake disc, a knuckle spindle 592 to which a lower arm not shown is attached, and a tie rod mounting ball joint 526.

A tie rod pushes tie rod mounting ball joint 526 in accordance with a steering angle, and thereby wheel 510 is steered.

An oil pump 524 for delivering oil for lubricating a retarder accommodated in inwheel motor 520 is provided at inwheel motor 520 on its rotation axis. Wiring clamp 522 is placed in a gap portion between shock absorber 560 and oil pump 524, which makes a wiring space compact.

Wiring clamp 522 fixes cables 534, 536, 538, and 540 to inwheel motor 520 in an intermediate portion between terminal box 532 and equipment at the vehicle body. Therefore, when the wheel is steered, or when the shock absorber elongates or contracts, it is possible to relieve stress exerted on the connectors attached to the terminal box, and thus wiring is less likely to break.

Furthermore, wiring clamp 522 fixes cables 534, 536, 538, and 540 such that the longitudinal direction of these cables are aligned with a direction parallel to the traveling direction of the vehicle. Therefore, wiring portions, from wiring clamp 522 to the vehicle body, are allowed to deform in a coplanar manner during steering, and thus torsional stress is less likely to be exerted on the wiring.

An arm to be attached to the shock absorber is provided at an upper portion of a housing of inwheel motor 520. This arm is fixed to outer cylinder 564 of shock absorber 560 by a clamp band 580, nuts 528 and 530, and a bolt not shown.

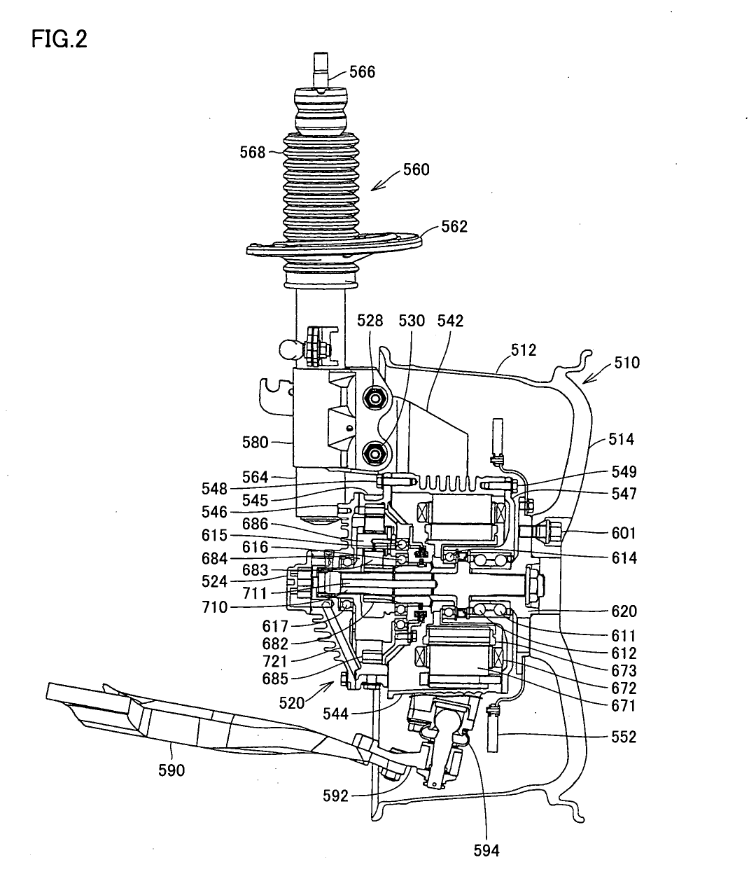

FIG. 2 is a schematic cross section of the driving unit according to the embodiment of the present invention.

Referring to FIGS. 1 and 2, wheel 510 includes a wheel disk 514 and a rim portion 512. A tire not shown is attached to rim portion 512.

A top end of piston rod 566 is fixed to the vehicle body not shown. Knuckle spindle 592 is fixed to a lower arm 590 by a bolt and a nut. A space between the vehicle body and shock absorber 560 can be utilized as a wiring space where a sensor cable and a power cable are arranged.

As shown in FIG. 2, the case of inwheel motor 520 is integrated into a knuckle that rotatably supports a wheel hub.

Referring to FIG. 2, inwheel motor 520 includes a motor housing 544, a gear case 545 attached to motor housing 544 by a bolt 548, a gear case lid 546 covering the gear case from the vehicle body side, and a motor housing lid 547 attached to motor housing 544 by a bolt 549.

A ball joint 594 is attached to motor housing 544, and thereby motor housing 544 is supported in such a manner that it can provide angular displacement with respect to knuckle spindle 592 in accordance with its vertical movement.

Wheel disk 514 is fixed to a wheel hub 620 by a bolt 601. A brake rotor 552 is attached to wheel hub 620. Wheel hub 620 is rotatably supported with respect to a motor case integrated into the knuckle, by providing ball bearings 611 and 612 between wheel hub 620 and motor housing lid 547.

Inwheel motor 520 includes a stator core 671 accommodated in motor housing 544, a stator coil 672 wound around stator core 671, and a rotor 673 accommodated in stator core 671. A permanent magnet is embedded in rotor 673.

Inwheel motor 520 further includes a sun gear 682 accommodated in gear case 545, a ring gear 685, a planetary carrier 684, a pinion gear 683, and a pin 686 serving as a rotating shaft of pinion gear 683. A needle bearing is provided in a gap between pinion gear 683 and pin 686.

A shaft of sun gear 682 rotates as rotor 673 rotates. The shaft of sun gear 682 is rotatably supported by a ball bearing 614 with respect to motor housing lid 547. Planetary carrier 684 is rotatably supported by a ball bearing 617 with respect to gear case lid 546.

Similarly, planetary carrier 684 is rotatably supported by a ball bearing 616 with respect to the shaft of sun gear 682, and is rotatably supported by a ball bearing 615 with respect to gear case 545.

Sun gear 682 is hollow. A shaft 710 having spline engagement with wheel hub 620 and planetary carrier 684 is placed in sun gear 682. Shaft 710 is provided with an oil passage 711 on the gear case side.

Rotor 673 included in inwheel motor 520 is hollow. The retarder decelerates the rotation of inwheel motor 520 and transmits the decelerated rotation to shaft 710 penetrating the hollow portion of rotor 673. Shaft 710 then rotates wheel hub 620 and wheel 510.

The movement of the retarder will be described in some detail. When rotor 673 rotates, sun gear 682 rotates accordingly. Ring gear 685 is fixed to gear case 545. Pinion gear 683 engages both of sun gear 682 and ring gear 685. When sun gear 682 rotates, pinion gear 683 also rotates accordingly. Since ring gear 685 is fixed to gear case 545, the ring gear does not rotate. Therefore, the rotation of sun gear 682 is decelerated, which causes planetary carrier 684 to rotate. Planetary carrier 684 has spline engagement with shaft 710, and thus the rotation of planetary carrier 684 causes wheel hub 620 to rotate via shaft 710, which causes wheel 510 to rotate.

To lubricate the retarder portion, oil pump 524 is attached to gear case lid 546. Oil pump 524 sucks lubricating oil, which collects at the bottom portion of the gear case, through an oil passage 721 to deliver the same to oil passage 711. Since oil pump 524 is preferably rotated by shaft 710 rotated by a large torque obtained after deceleration, oil pump 524 is provided on shaft 710 on the vehicle body side such that it protrudes therefrom.

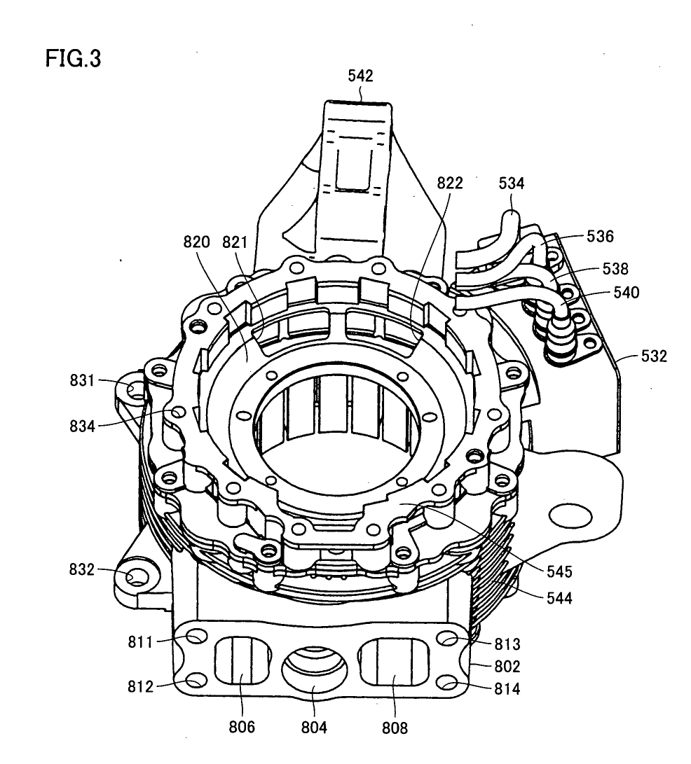

FIG. 3 is a perspective view showing how gear case 545 and motor housing 544 in FIG. 2 are assembled.

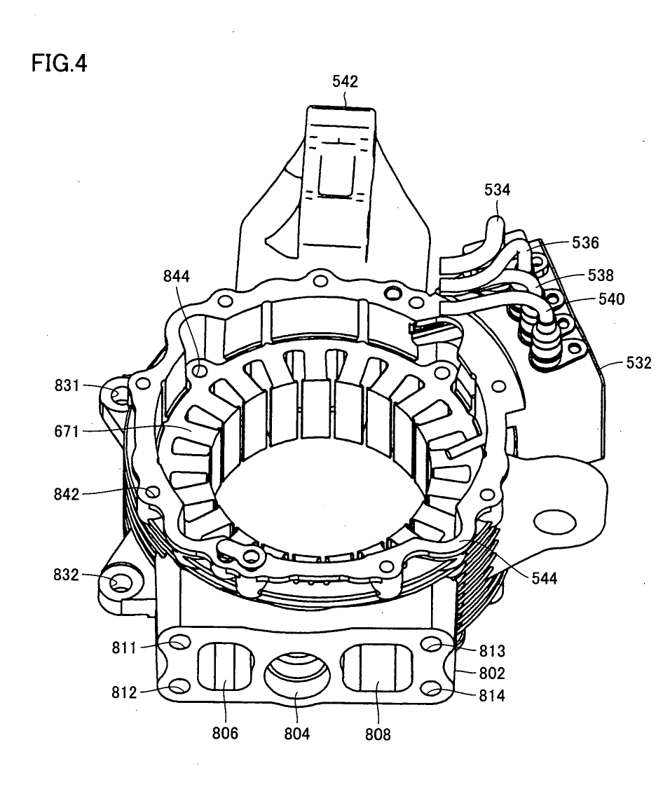

FIG. 4 is a perspective view showing a state shown in FIG. 3 with gear case 545 removed.

Referring to FIGS. 3 and 4, gear case 545 and motor housing 544 are assembled by fastening a bolt inserted into a bolt hole 842.

At a partition wall 820 disposed at gear case 545 between gear case 545 and the motor housing, openings 821 and 822 are provided for splashing the lubricating oil, which has been splashed by a planetary gear unit, onto the upper portion of motor housing 544 and the outer periphery of the stator coil.

Partition wall 820 is provided at a gear room that supports ball bearings 616 and 686 shown in FIG. 2.

When gear case 545 is removed, it is possible to see how stator core 671 is accommodated in motor housing 544. Stator core 671 is fixed to motor housing 544 by a bolt inserted into a bolt hole 844.

At the outer portion of motor housing 544, an arm 542 to be attached to shock absorber 560, terminal box 532 for connecting sensor cable 534, and power cables 536, 538 and 540 of U, V and W phases, respectively, bolt holes 831 and 832 for attaching brake caliper 550, and a connection portion 802 for connecting motor housing 544 to lower arm 590 are provided.

Connection portion 802 is provided with cavities 806 and 808 for reducing weight, a hole 804 for fitting the ball joint thereinto, and bolt holes 811-814 for fastening a lid for pressing the ball joint.

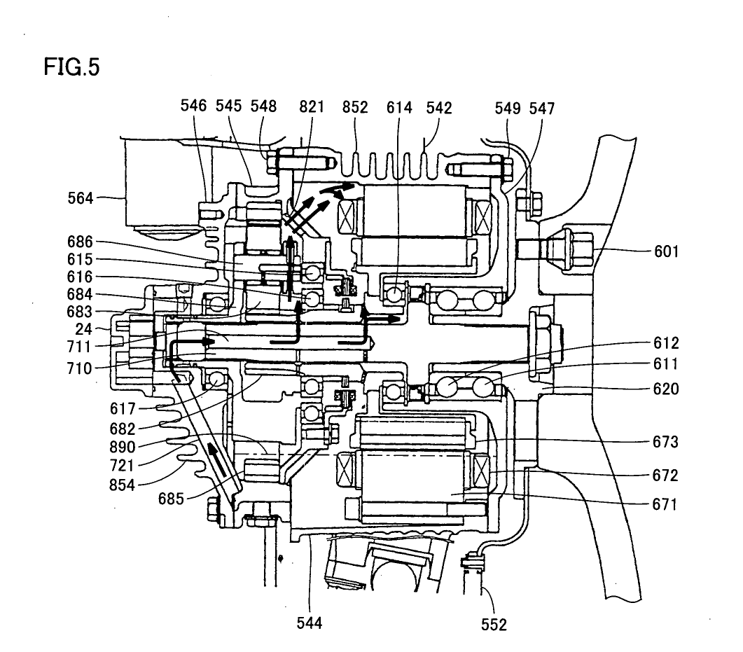

FIG. 5 is a view for explaining a flow of the lubricating oil splashed by a reduction gear. In FIG. 5, for easy understanding of the path of the splashed lubricating oil, a wall portion for maintaining the strength between openings 821 and 822 in FIG. 3 is not shown in the wall 820 portion. Instead, a characteristic cross section of the opening 821 portion is shown.

Referring to FIG. 5, motor housing 544 accommodating the stator and the rotor, and gear case 545 accommodating a planetary gear to which rotation of the rotor is transmitted, are arranged adjacently along a direction of a rotation axis of the rotor. Bearings 615 and 616 for supporting the rotation of rotor 673 or the planetary gear are supported by the wall between motor housing 544 and gear case 545 room. The wall is provided with opening 821 for splashing the lubricating oil, which has been splashed by the gear, onto the upper portion of the stator.

The planetary gear is a reduction gear decelerating the rotation of rotor 673 and transmitting the rotation to shaft 710 causing wheel 510 to rotate. The reduction gear includes ring gear 685 fixed to a wall of gear case 545, sun gear 682 to which the rotation of rotor 673 is transmitted, planetary carrier 684 fitted into shaft 710, and pinion gear 683 having a rotating shaft supported by planetary carrier 684 and engaging sun gear 682 and ring gear 685.

A cooling fin 852 is provided outside a wall portion of the motor room, the lubricating oil splashed from the planetary gear through opening 821 adhering to the wall portion of the motor room.

The amount of oil is set such that an oil fluid level 890 is positioned slightly lower than the inner peripheral surface of stator core 671. Oil pump 524 sucks the lubricating oil at oil fluid level 890 through oil passage 721.

Some of the lubricating oil passes through oil passage 711 placed at the central portion of shaft 710 and through an oil passage provided at the planetary carrier, and is then splashed through opening 821 onto the outer periphery of stator coil 672. Furthermore, some of the lubricating oil is also splashed by pinion gear 683, and similarly splashed through opening 821 onto the stator coil and the inner peripheral wall of the motor housing.

Accordingly, the stator coil and the stator core are cooled. A heat radiating fin 852 is provided outside the wall of the motor housing, the lubricating oil being splashed through opening 821 onto the wall of the motor housing. Therefore, the heat of the lubricating oil is radiated to the air by fin 852.

Furthermore, the splashed lubricating oil infiltrates into a gap between the stator coil and the wall of the motor housing. Accordingly, better heat transfer from the stator coil to the wall of the motor housing is achieved than in the case where the gap is filled with air. Therefore, heat radiation is also improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A driving unit, comprising:
a motor room accommodating a stator and a rotor;
a gear room arranged adjacently to said motor room along a direction of a rotation axis of said rotor and accommodating a gear, rotation of said rotor being transmitted to the gear;
a bearing for supporting rotation of either of said rotor and said gear; and
a wall disposed between said motor room and said gear room for supporting said bearing, wherein said wall is provided with an opening for allowing lubricating oil splashed by said gear to be splashed onto an upper portion of said stator.

2. The driving unit according to claim 1, placed in a wheel of a vehicle.

3. The driving unit according to claim 2, wherein
said gear is a reduction gear decelerating the rotation of said rotor and transmitting the rotation to a shaft causing said wheel to rotate, and
said reduction gear includes
a ring gear fixed to a wall of said gear room,
a sun gear to which the rotation of said rotor is transmitted,
a planetary carrier fitted into said shaft, and
a pinion gear having a rotating shaft supported by said planetary carrier and engaging said sun gear and said ring gear.

4. The driving unit according to claim 3, further comprising a cooling fin provided outside a wall portion of said motor room, the lubricating oil splashed from said gear through said opening adhering to the wall portion of said motor room.

5. The driving unit according to claim 2, further comprising a cooling fin provided outside a wall portion of said motor room, the lubricating oil splashed from said gear through said opening adhering to the wall portion of said motor room.

6. The driving unit according to claim 1, wherein
said gear is a reduction gear decelerating the rotation of said rotor and transmitting the rotation to a shaft causing a wheel to rotate, and
said reduction gear includes
a ring gear fixed to a wall of said gear room,
a sun gear to which the rotation of said rotor is transmitted,
a planetary carrier fitted into said shaft, and
a pinion gear having a rotating shaft supported by said planetary carrier and engaging said sun gear and said ring gear.

7. The driving unit according to claim 6, further comprising a cooling fin provided outside a wall portion of said motor room, the lubricating oil splashed from said gear through said opening adhering to the wall portion of said motor room.

8. The driving unit according to claim 1, further comprising a cooling fin provided outside a wall portion of said motor room, the lubricating oil splashed from said gear through said opening adhering to the wall portion of said motor room.
